(19) United States
(12) Patent Application Publication
(10) Pub. No.: US 2012/0216120 A1
(43) Pub. Date: Aug. 23, 2012

(54) METHOD AND APPARATUS FOR RENDERING A MULTIMEDIA ITEM WITH A PLURALITY OF MODALITIES

(75) Inventor: Gerard De Haan, Eindhoven (NL)

(73) Assignee: KONINKLIJKE PHILIPS ELECTRONICS N.V., EINDHOVEN (NL)

(21) Appl. No.: 13/505,097

(22) PCT Filed: Oct. 28, 2010
(86) PCT No.: PCT/IB2010/054880

§ 371 Date: Apr. 30, 2012

(30) Foreign Application Priority Data
Nov. 6, 2009 (EP) 09175184.2

(51) Int. Cl. G06F 3/01

(52) U.S. Cl. 715/716

(57) ABSTRACT

A method and apparatus for rendering a multimedia item with a plurality of modalities is provided. Parameter settings are determined for a plurality of modalities according to a user input request (step 206). The multimedia item is rendered with the determined Render menu of modes 202 modality parameter settings (step 208).

### FIELD OF THE INVENTION

The present invention relates to a method and apparatus for rendering a multimedia item with a plurality of modalities.

### BACKGROUND OF THE INVENTION

Modern multimedia systems can be used both in relaxed (for example, bedroom TV) and immersive (for example, home-theatre) applications. For a relaxed application, a user of the multimedia system would require the system to render a multimedia item with, for example, mono sound audio with low bass and treble, video having low contrast and colour saturation, and ambient lighting having a slow temporal response. For an immersive application, a user of the multimedia system would require the system to render a multimedia item with, for example, surround sound audio with high bass and treble, video having high contrast and colour saturation, and ambient lighting having a fast temporal response.

A user of the multimedia system may also require variations of these applications depending on how relaxed or immersive the user would like their viewing experience of a rendered multimedia item to be. Also, the preferred scenario may change over time such as during the daytime or during the evening. For example, if the user is watching a movie, the user is likely to require a very immersive setting, whereas later in the evening the user may prefer a more relaxed setting.

Although existing devices allow the user to change the settings of a device to attempt to create a more immersive or a more relaxed mode, these devices are not very user friendly. The existing devices require a user to navigate through many menu options and to modify each setting of the device individually to create a desired mode. This can be time consuming for a user and it is difficult for a user to intuitively know under which menu option each setting can be found.

Also, by altering many different settings individually in this way, the user creates a risk that the optimal or standard settings of the device are difficult to reset when a user wishes to return to them. The user would need to go back through the many menu options to reset each of the settings and would also be required to remember what the original optimal or standard settings were in order to reset them. The changing of so many settings may discourage the user to an extent that the user would rather switch off the device altogether.

### SUMMARY OF THE INVENTION

The invention seeks to provide a method and apparatus that provides a user-friendly way in which to control how a multimedia item is rendered.

This is achieved, according to one aspect of the present invention, by a method for rendering a multimedia item with a plurality of modalities, the method comprising the steps of: determining parameter settings for the plurality of modalities according to a user input request; and rendering the multimedia item with said determined modality parameter settings.

This is also achieved, according to a second aspect of the present invention, by apparatus for rendering a multimedia item with a plurality of modalities, the apparatus comprising: a processor for determining parameter settings for the plurality of modalities according to a user input request; and a rendering device for rendering the multimedia item with the determined modality parameter settings.

In this way, a user is not required to navigate through many menu options to adapt parameter settings. In contrast, a user is able to adapt parameter settings for a plurality of modalities using only a single action. This provides a quick and easy way to control how a multimedia item is rendered. This means that the optimal or standard settings of the device can easily be returned to with a single action.

The user input request may be generated upon a user performing a single action.

The plurality of modalities may include at least one of, at least two of or all of audio, video and ambient lighting.

The parameter settings for audio may include at least one of volume, tempo, treble and bass, stereo-width, surround, and dynamic range. The parameter settings for video may include at least one of contrast, saturation, sharpness, and dimensions. The parameter settings for ambient lighting include at least one of colour, light intensity, dynamic range, saturation and pace of light change.

A range may be provided for the user input request. The user input request may correspond to an immersive effect, and may correspond to a low immersive effect or a high immersive effect, or any intermediate levels therebetween.

### BRIEF DESCRIPTION OF THE DRAWINGS

For a better understanding of the invention, and to show more clearly how it may be carried into effect, reference will now be made, by way of example only, to the accompanying drawings in which:

FIG. 1 is a simplified schematic of apparatus for rendering a multimedia item with a plurality of modalities in accordance with the invention; and

FIG. 2 is a flowchart of a method for rendering a multimedia item with a plurality of modalities in accordance with the invention.

### DETAILED DESCRIPTION

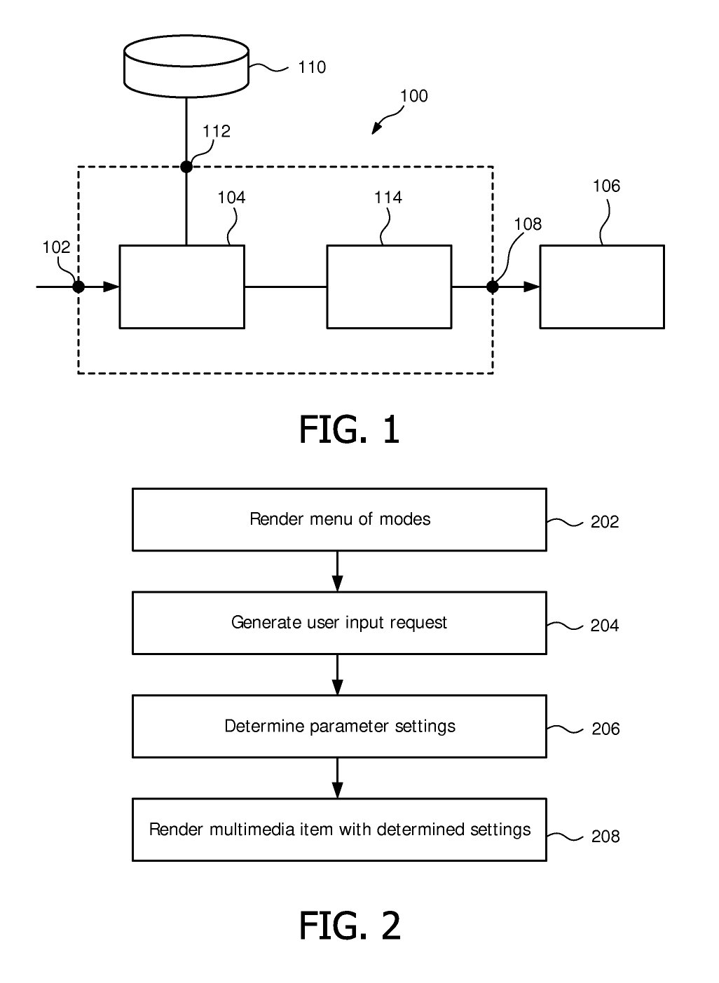

With reference to FIG. 1, the apparatus 100 comprises a first input terminal 102 for receiving a user input request. The first input terminal 102 is connected to a processor 104. A multimedia storage device 110 is connected to the processor 104 via a second input terminal 112. The multimedia storage device 110 may be integral with the apparatus 100 (for example, an internal memory) or may be external to the apparatus 100 (for example, a remote memory). The multimedia storage device 110 provides multimedia items to the processor 104. The multimedia items may be, for example, broadcast TV channels, broadcasts via the internet, radio broadcasts, films, tracks, images, etc.

The output of the processor 104 is connected to a controller 114, which controls a rendering device 106 via an output terminal 108. The rendering device 106 outputs multimedia items and may be, for example, a television, an audio device, a personal computer, etc. The rendering device 106 may be integral with the apparatus 100 or may be external to the apparatus 100.

The operation of the apparatus 100 will now be described with reference to the flowchart shown in FIG. 2.

The controller 114 controls the rendering device 106 via the output terminal 108 such that the rendering device 106 renders a menu that has a plurality of modes (for example, vivid, movie, standard, soft, etc) as menu options (step 202). The modes correspond to a range of immersive effects, ranging from a high immersive effect to a low immersive effect with intermediary immersive effects in between. This may be input by use of a slider scale of the desired level of immersion. Each of the immersive effects has associated parameter settings for a plurality of modalities. A user is able to select a mode for rendering a multimedia item with the corresponding immersive effect.

The plurality of modalities may include at least one of, at least two of or all of audio, video and ambient lighting. The parameter settings for audio may include at least one of volume, tempo, treble and bass, stereo-base width, surround, and dynamic range. The parameter settings for video may include at least one of contrast, saturation, sharpness, and dimensions. The parameter settings for ambient lighting may include at least one of colour, light intensity, dynamic range, saturation and pace of light change.

A user performs a single action to generate a user input request by selecting a mode from the rendered menu (step 204). For example, a user may select a menu option via a user input device. The user input device may include a scroll bar, which can be operated by a user to scroll through the modes (range of immersive effects). A user could then select a desired immersive effect from the range by pressing a button on the user input device. Alternatively, a user may select an immersive effect from the range via a touch screen on the rendering device 106.

The first input terminal 102 receives the user input request and inputs the user input request into the processor 104. The processor 104 determines parameter settings for the plurality of modalities according to the user input request (step 206).

If the user input request corresponds to a low immersive effect, the processor 104 determines parameter settings for a plurality of modalities which would provide a low immersive effect. For audio, the processor 104 determines decreased volume, decreased treble and bass, decreased dynamic range, and mono sound. For video, the processor 104 determines compressed contrast, low saturation, modest sharpness, and 2D rendering for example. For ambient lighting, the processor 104 determines weak colour, weak light intensity, low dynamic range, low saturation and slow pace of light change for example.

If the user input request corresponds to a high immersive effect, the processor 104 determines parameter settings for a plurality of modalities which would provide a high immersive effect. For audio, the processor 104 determines increased volume, increased treble and bass, expanded dynamic range, and surround sound. For video, the processor 104 determines boosted contrast, high saturation, aggressive sharpness, and 3D rendering. For ambient lighting, the processor 104 determines strong colour, strong light intensity, high dynamic range, high saturation and fast pace of light change for example.

The processor 104 inputs the determined parameter settings for the plurality of modalities into the controller 114. The controller 114 controls the rendering device 106 via the output terminal 108 such that the rendering device 106 renders the multimedia item with the determined modality parameter settings (step 208).

A user is able to change the immersive effect at any time by the method described above. Additionally, if a user makes individual selections of parameter settings, the processor 104 creates a new mode for the combination of settings, which can subsequently be chosen by the user with a single action. In this way, the apparatus 100 is able to learn user preferences and create more personal modes. In an alternative embodiment, if an immersion level is chosen, individual parameters may altered manually, like the sound volume, but the effect of this individual adaptation is temporary, i.e. it would overruled the next time the “immersion level” is chenged.

The apparatus 100 may be further capable of adapting the immersive effect depending on the time of day, the user, and the type of multimedia item being rendered. For example, if a user is watching a movie, a very immersive setting may be attractive, whereas later in the evening a more relaxed setting may be preferred.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for rendering a multimedia item with a plurality of modalities, the method comprising the steps of:
determining (206) parameter settings for said plurality of modalities according to a user input request; and
rendering (208) said multimedia item with said determined modality parameter settings.

2. The method according to claim 1, wherein said plurality of modalities includes at least one of audio, video and ambient lighting.

3. The method according to claim 2, wherein said plurality of modalities includes at least two of audio, video and ambient lighting.

4. The method according to claim 3, wherein said plurality of modalities includes audio, video and ambient lighting.

5. The method according to claim 1, wherein the parameter settings for audio include at least one of volume, tempo, treble and bass, stereo-base width, surround, and dynamic range.

6. The method according to claim 1 wherein the parameter settings for video include at least one of contrast, colour saturation, sharpness, and dimensions.

7. The method according to claim 1 wherein the parameter settings for ambient lighting include at least one of colour, light intensity, dynamic range, saturation and pace of light change.

8. The method according to claim 1, wherein the method further comprises the step of providing a range for said user input request.

9. The method according to claim 1, wherein said user input request corresponds to an immersive effect.

10. The method according to claim 9, wherein said user input request corresponds to a low immersive effect.

11. The method according to claim 9, wherein said user input request corresponds to a high immersive effect.

12. A computer program product comprising a plurality of program code portions for carrying out the method according to claim 1.

13. Apparatus for rendering a multimedia item with a plurality of modalities, the apparatus comprising:
a processor (104) for determining parameter settings for said plurality of modalities according to a user input request; and
a rendering device (106) for rendering said multimedia item with said determined modality parameter settings.
